(19) United States
(12) Patent Application Publication
(10) Pub. No.: US 2003/0182164 A1
(43) Pub. Date: Sep. 25, 2003

(54) Optical report archiving

(75) Inventors: M. Michael Shabot, Los Angeles, CA (US); Mark Lobue, Palmdale, CA (US); Raymond Duncan, Los Angeles, CA (US)

Correspondence Address: Pillsbury Winthrop LLP, Intellectual Property Group, Suite 2800, 725 South Figueroa Street, Los Angeles, CA, 90017-5406, US

(73) Assignee: Cedars-Sinai Medical Center, Los Angeles, CA

(21) Appl. No.: 10/385,068

(22) Filed: Mar. 10, 2003

Related U.S. Application Data
(60) Provisional application No. 60/363,074, filed on Mar. 11, 2002.

(51) Int. Cl. G06F 17/60; G06F 7/00; G06F 17/00

(52) U.S. Cl. 705/3; 707/104.1

(57) ABSTRACT

An optical report generation system includes a clinical information system (“CIS”) server to store raw monitoring data for at least one patient and to generate optical reports, at a predetermined time interval, based on the raw monitoring data. The CIS server includes a database. A control server determines the reports to generate, based on the raw monitoring data. The optical reports include all possible optical reports which can be generated based on the raw monitoring data.

This application claims the benefit of priority under 35 U.S.C. §119 of provisional application serial No. 60/363,074, filed Mar. 11, 2002, the contents of which are hereby incorporated by reference in their entirety as if fully set forth.

### BACKGROUND

1. Technical Field

This invention relates to the field of optical record archival and optical record viewing.

2. Description of the Related Arts

During the past two decades, information systems have been developed to receive, display and record data relating to the care of patients in intensive care units (“ICUs”) and other patient areas. Most current systems typically prepare only a computer-generated paper report as the final medicolegal report for the patient. Reports concerning the patient's vital statistics, as well as caregiver notes and bedside care activities are typically printed on a shift-by-shift basis, to provide a legal record of each provider's role in the care of each patient. However, printing the reports out after each shift results in an exorbitant amount of paper for each patient. Moreover, the reports are often bulky and difficult to sort, manage and store across the continuum of care.

There are some optical record recording systems in the art. However, such systems typically require a user to manually enter or initiate the aggregation of data to be recorded in an optical record. Some of these systems archive all possible medical reports at certain fixed times of the day. Such systems are designed to archive all possible reports; otherwise, parts of the required medicolegal chart will not be stored. In typical situations, not all patients will have data for all possible reports. For example, patients who are not on a ventilator would have a blank ventilator report printed to optical archive. Therefore, this approach typically generates many thousands of empty reports over the course of a year. Aside from wasting space in the archive, storing empty reports permanently makes reviewing such charts difficult.

Other systems archive all medical reports that are manually selected by a nurse/caregiver for physical printing (i.e., to a printer). Such systems require nurses/caregivers to physically print all needed reports and then throw the paper away, because the official medicolegal record can be defined as the electronic copy in the optical archive for hospitals/care centers. Additionally, this option requires the nurse/caregiver to remember to print all the reports for which data has been stored during the nursing shift. The nurse/caregiver is often unaware of data that other nurses, therapists and other caregivers have stored during the nursing shift, or of data stored automatically by other electronic systems, so the nurse/caregiver often does not print all of the reports that need to archived, resulting in necessary reports not being saved in the optical archive.

Additionally, both options fail to maintain a medicolegally complete chart. This failure relates to “late entries” in the chart. “Late entries” are defined as entries made after the charts for the nursing have been printed and/or stored in the archive, either automatically or manually. There are many reasons why “late entries” occur in patient charts. For example, nurses/caregivers often forget to make an entry and then remember and enter it later, or they may be too busy to make the entry until after the shift is over. Lab results for blood drawn near the end of a shift are an example of data often transmitted to a clinical information system after the end of a shift. For such “late entries,” updated reports containing the entries will be printed to the optical archive only if a nurse/caregiver subsequently on duty knows or remembers to reprint the report for the prior shift. In the case of later-returning lab data, there is nobody available to “remember” or know when to do this. Accordingly, such “late entries” often are often missing from the optical archive.

Current systems for viewing such medical records are also deficient. Such systems require a user to separately log in to different databases to view certain types of reports. For example, to view X-rays, the user has to log in to an application program to view X-rays. To view ICU reports, the user has to log in to an ICU database. To view other types of reports, the user would have to log in to additional application programs. Having to log in to multiple application programs can be very time-consuming, cumbersome, and confusing for users who often have many different login names and passwords. Also, a hospital/medical center has no easy way of knowing which users have accessed the various application programs and viewed reports of confidential patient data.

### BRIEF DESCRIPTION OF THE DRAWINGS

FIG. 1 illustrates an optical archiving system according to an embodiment of the invention;

FIG. 2A illustrates a control server according to an embodiment of the invention;

FIG. 2B illustrates a web viewing system according to an embodiment of the invention;

FIG. 3 illustrates a method of querying the database of the CAREVUE CIS servers according to an embodiment of the invention;

FIG. 4 illustrates a browser selection webpage according to an embodiment of the invention;

FIG. 5A illustrates an archived report selection page according to an embodiment of the invention;

FIG. 5B illustrates an alternative archive report selection page according to an embodiment of the invention;

FIG. 6A illustrates an Vital Signs optical report according to an embodiment of the invention;

FIG. 6B illustrates a Vital Signs and Intake/Output optical report according to an embodiment of the invention;

FIG. 6C illustrates a Ventilator Flowsheet according to an embodiment of the invention; and

FIG. 7 illustrates a method of operating the web viewing system according to an embodiment of the invention.

### DETAILED DESCRIPTION

An embodiment of the invention may interact with existing medical data acquisition devices to ensure that complete medicolegal records are archived in an optical archive for subsequent viewing. The embodiment may be in communication with a commercially available “Clinical Information System” (“CIS”), such as CAREVUE (available from Philips Medical Systems Cardiac and Monitoring Systems; Andover, Mass.), having a function of acquiring data for monitored patients in a medical environment, such as an Intensive Care Unit (“ICU”) or any other type of patient care unit. CAREVUE acquires data for all patients under care and stores such raw data in database(s) of ICU servers. The embodiment may include a control server to query the configuration of the database(s) to determine which data is unique to which reports. Once the unique data is known, the control server may determine which reports should be generated. The control server may then query the database to determine which of the raw data belongs to which patient, and which data for a particular patient belongs to which report.

After such queries have been completed, the control server may also determine the “time of storage” for the data for each report. Optical reports are typically generated by CAREVUE at set intervals, such as at the end of a medical shift. However, if information has not yet been entered into the CAREVUE system at the time the report is generated, such information will be missing from the reports. To ensure that late entries of data end up in an optical report, the control server determines the time of storage for the information for each report. If all information is within the shift for a report, then the report will be noted as having been generated during the shift (i.e., for an 8:00 AM-8:00 PM shift, the report will list the start time as 8:00 AM and the finish time as 8:00 PM). However, if any information for a report was stored after the report for a previous shift was generated, the system may automatically reprint the report to ensure that the optical archive includes a complete report for the period of time the information was acquired. In other words, if some information is for 6:30 AM, before the start of the shift, then the report will be modified to reflect this start time (i.e., for an 8:00 AM-8:00 PM shift, the report will list the start time as 8:00PM the prior day and the finish time as 8:00 PM the current day).

Once the control server has determined which reports to create for which users, and determined the time of entry, the control server may communicate with the CAREVUE system to instruct CAREVUE as to which reports need to be created, and the time period the report needs to cover. Accordingly, at the interval when the reports are generated, CAREVUE generates the reports according to the instructions of the control server, thereby preventing blank, or dataless, reports from being automatically generated by CAREVUE while simultaneously ensuring that complete reports including “late entries” are stored in the optical archive. CAREVUE may then send the report to a report capture server which creates the optical report, which in turn sends the optical report to a report capture archive, which writes the optical reports onto optical media. The optical media is then placed in an optical jukebox, and the optical reports contained thereon may be accessed via a web-based viewing system.

The web-based viewing system may include enterprise software to allow a user to access the CAREVUE optical reports, as well as other types of reports such as X-ray images and lab results, for example. The enterprise software may provide a convenient way of allowing a user to access multiple types of reports, which having to separately login to each individual type of report system. The enterprise software may also log the name of users accessing such reports, for privacy purposes.

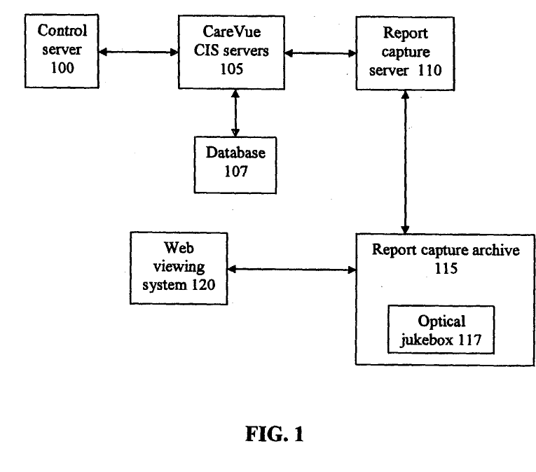

FIG. 1 illustrates an optical archiving system according to an embodiment of the invention. The optical archiving system may include CAREVUE CIS servers 105. As discussed above, CAREVUE is an example of a commercially available CIS. In other embodiments, a type of CIS other than CAREVUE may be utilized. The CAREVUE CIS servers 105 may be utilized to acquire data for patients being monitored in a hospital environment, such as an ICU. The CAREVUE CIS servers 105 may store the acquired raw data for all patients being monitored in a database. The CAREVUE CIS servers 105 may be in communication with a control server 100. The CAREVUE CIS servers 105 may generate reports based on the data stored therein and transmit the reports to the report capture server 110. The control server 100 may be utilized to control the reports which are generated by the CAREVUE CIS servers 105. The control server 100 may cause the CAREVUE CIS servers 105 to generate only reports based on data stored in the servers 105, instead of generating all possible reports including empty reports.

The control server 105 may query the configuration of the database 107 for the CareVue CIS servers 105 to determine which data is unique to which reports. For example, a patient's name, weight, and age may be utilized to generate all reports. However, other data such as a blood gas measurement may be unique to a specific report, such as a “blood gas” report. Accordingly, because the control server 100 is designed to generate only the necessary reports (i.e., the reports for which data has been measured for the patient and is located in the database), the control server 100 needs to know which data goes with which report.

After the configuration is determined, the control server 100 may then query the database 107 to determine which of the data contained therein belongs to which patient. For example, if there are 10 patients being monitored in the ICU, there may be data for all 10 patients in the database 107. The control server 100 then queries the database 107 to determine which of the data for a particular user belong to which reports. For example, the control server 100 may need to determine all data necessary to generate a blood gas report for a patient, such as, e.g., (a) data common to all reports for that particular patient including the patient's name, age, weight, etc., and (b) data unique to the blood gas report such as a measurement of the patient's blood gas level. Next, the control server 100 may direct the CAREVUE CIS servers 105 to generate only the reports determined by the control server 100 to be “necessary” (e.g., those reports which include data updated during the nursing shift).

Once instructed as to which reports to generate, the CAREVUE CIS servers 105 may generate the reports. The CAREVUE CIS servers 105 may generate the reports at a set interval, such as immediately after the end of a shift. Alternatively, the control server 100 may wait until the end of the shift to perform its queries, and only after at least some of its queries have completed will the instructions to generate the reports be sent to the CAREVUE CIS servers 105. Once generated, the reports may be sent to the report capture server 110, where they are queued until being transmitted to an optical report archive 115. The optical report archive 115 may write the received reports onto recording media such as one, two or more storage discs. The storage discs may be optical media. The reports may be written to both storage discs simultaneously, or one after the other. In other embodiments, the reports may be written to a single disc or to more than two discs. In an embodiment, each disc may be a cartridge capable of holding 5.2 GB of data; although optical cartridges of alternate storage capacities may be used as well. Each disc may be a Write Once Read Many (“WORM”) cartridge which cannot be altered once written to. In other embodiments, each disc may be formed of a different type of optical media such a compact disc (“CD”) or a DVD. In additional embodiments, the discs may be disc drives similar to those commonly used in personal computers, or large arrays of random access memories (“RAM”). One of the storage discs may be placed in an optical jukebox 117 when completely written. The other storage disc may serve as a backup and may be removed for safe keeping.

The optical reports stored in the optical jukebox 117 may be accessible via a web viewing system 120. The sum of all reports contained within the optical jukebox, as well as the reports in the process of being written may be known as the “report archive.” The web viewing system 120 may provide access to essentially all clinical data at the hospital/medical care center, including laboratory results, all dictated reports, radiology reports and images (“PACS”), Pathology reports, ECGs, ICU flowsheets, monitored bed waveforms, Labor and Delivery and Emergency Department records, etc. The web viewing system 120 may include HTML code to allow CAREVUE reports to be instantly retrieved from the report archive just like the clinical data mentioned above. A web browser plug-in may be necessary to view individual reports. All clinical workstations in the hospital/medical care center may have the plug-in installed as part of their basic configuration. The web viewing system 120 may be utilized to provide a central location for logging the reports viewed/requested by a particular user. Accordingly, the logging may be determined by the web viewing system 120, rather than at the website of the third-party who provides the CAREVUE report viewing system. Also, the web viewing system 120 may allow the user to access CAREVUE, as well as X-ray reports, Labor and Delivery and Emergency Department records, etc., without having to separately login to each of the servers for the aforementioned systems.

Optical recording media is not required for all embodiments of this invention. In alternate embodiments, the recording media may be magnetic disks, magnetic tape, random access memory or any other storage media. However, “write once” optical media is an ideal recording media for the medicolegal chart because it is durable and the data can not be altered once it has been written.

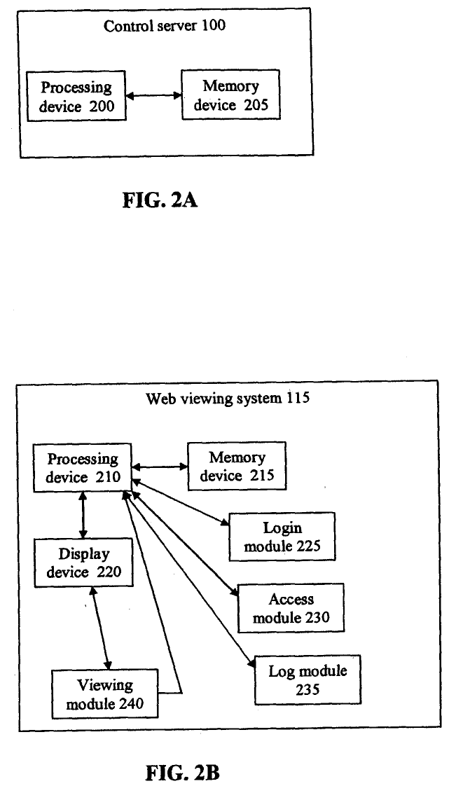

FIG. 2A illustrates a control server 100 according to an embodiment of the invention. As shown, the control server 100 may include a processing device 200 and a memory device 205. The processing device 200 may execute code stored in the memory device 205 to implement the query method of the control server 100.

FIG. 2B illustrates a web viewing system 115 according to an embodiment of the invention. As shown, the web viewing system 120 may include a processing device 210 and a memory device 215. The processing device 210 may execute code stored in the memory device 215 to implement the web viewing function of the web viewing system 120. The web viewing system 120 may also include a display device 220, such as a monitor. Alternatively, the display device 220 may be located remote from the web viewing system 120. The web viewing system 120 may also include a login module 225 to request a login and password from a user. An access module 230 allows the user to access reports in a valid login and password are entered. A log module 235 may record the options selected by the user, as well as reports selected for viewing. A viewing module 240 may provide selected reports to the display device for viewing.

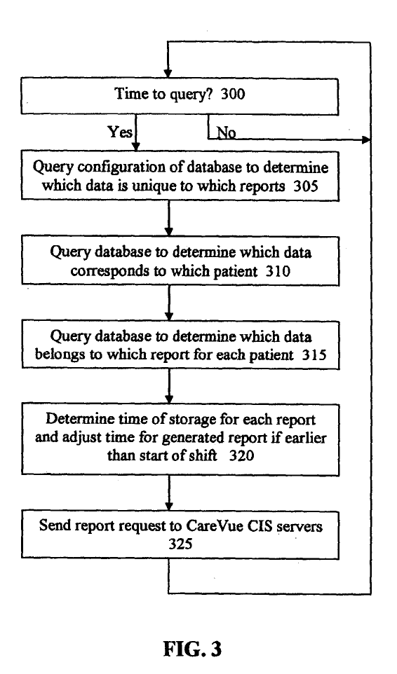

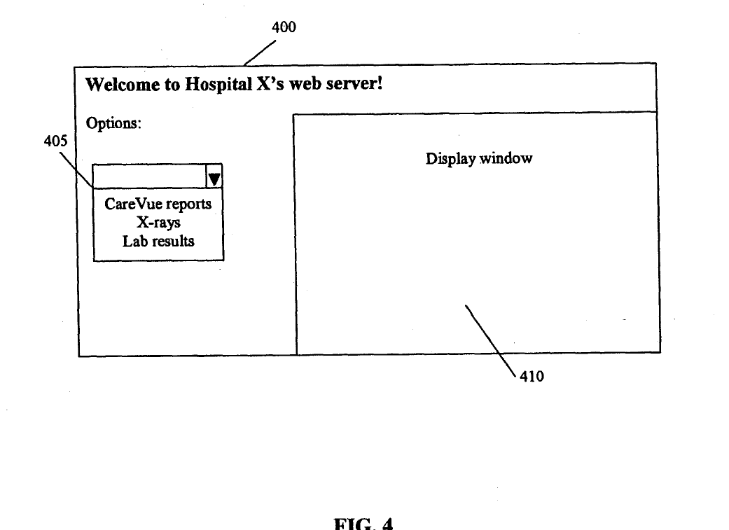

FIG. 3 illustrates a method of querying the database 107 of the CAREVUE CIS servers 105 according to an embodiment of the invention. First, the control server 100 may determine 300 whether it is time to query the database 107. As discussed above, the query may occur just after the end of a shift or at any other suitable time. If “no,” processing remains at operation 300. If “yes,” processing proceeds to operation 305, where the configuration of the database 107 is queried to determine which data is unique to which reports. Next, the database 107 is queried 310 to determine which data corresponds to which patient. Then, the database 107 is queried 315 to determine which data belongs to which reports for each patient. In other embodiments, the order in which operations 310 and 315 are performed may be reversed. The control server 100 may then determine 320 the time of storage for each report and adjust the time for the report to be generated if the time is earlier than the start of the shift. In other words, the control server 100 may determine whether any of the data in the database 107 corresponds to any shift earlier than the shift at issue. If any such data is for earlier shifts, then the time of creation for the record corresponding to that data is automatically adjusted to reflect this earlier time. A report request is then sent 325 to the CAREVUE CIS servers 105, and the requested reports are generated.

After the selected reports have been generated and stored in the report archive, they are viewable by a user of the web viewing system 120. To view the reports, a user may login to a web viewing application program. Once logged in, the web viewing system allows the user to access the CAREVUE reports, or various other reports such as X-Rays, laboratory results, all dictated reports, radiology reports and images (“PACS”), Pathology reports, ECGs, ICU flowsheets, monitored bed waveforms, Labor and Delivery and Emergency Department records, etc.

FIG. 4 illustrates a browser selection webpage according to an embodiment of the invention. First, the user may be prompted for a login and password. If the user enters a valid login and password, the user may reach the main page 400 of the browser selection webpage. On the left side of the main page 400 may be a report pull-down menu 405, from which the user may select the types of reports to view. For example, the user may select CAREVUE, X-rays, lab results, etc., as the type of reports to view. The user's selection may then be logged by the web browser program. In other embodiments, additional types of reports may be accessed. Once the type of report has been selected, the user may access an application program via the web browser to view the selected reports. The user may the view the selected reports without having to login separately to the various available applications programs for viewing reports. Once selected, the application program may be displayed in display window 410.

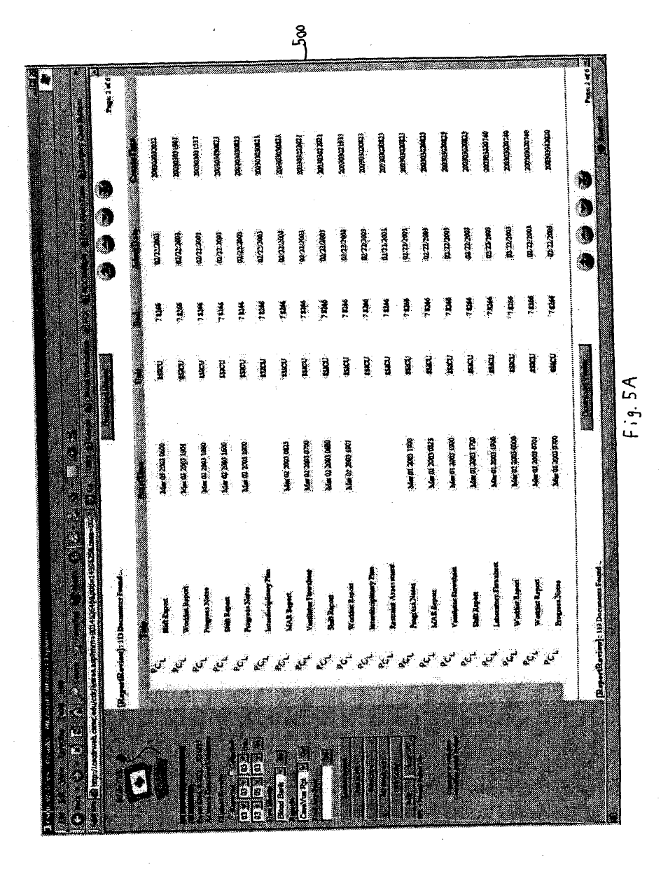

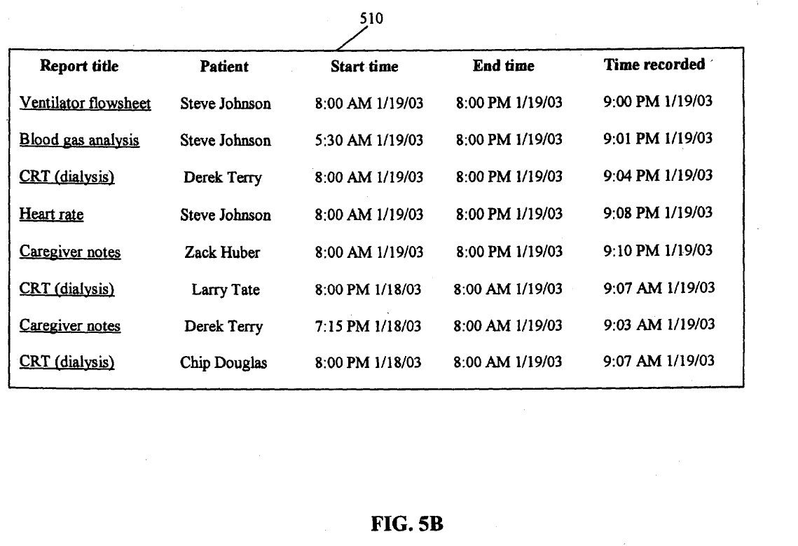

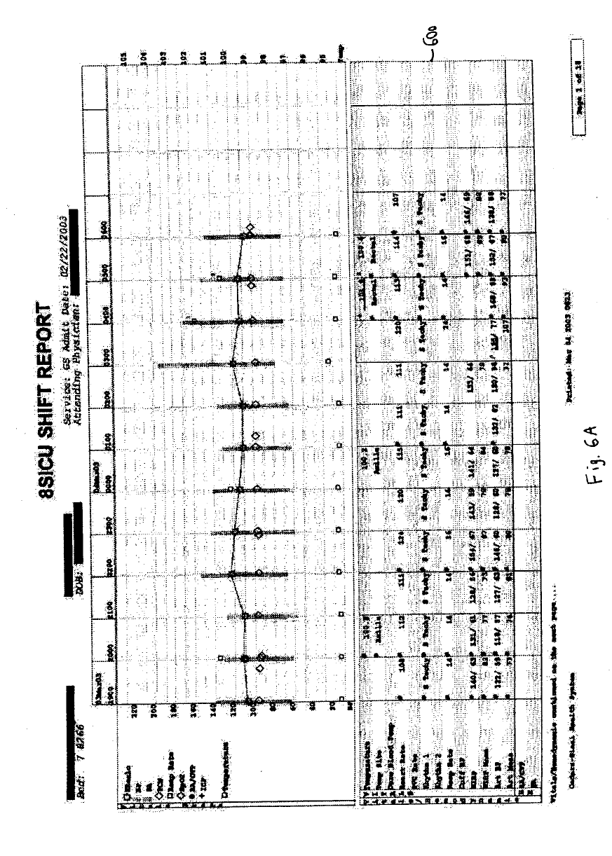

FIG. 5A illustrates an archived report selection page 500 according to an embodiment of the invention. Once logged into the web viewing system program, the user may select any reports in the displayed list for viewing. All of the listed reports contain data. In other words, none of the reports are blank, empty or “dataless.” As shown, a Progress Notes report (i.e., the third report from the top) is available for a selected patient. This report is for the shift between 19:00 on Mar.2, 2003 and 07:00 on Mar. 3, 2003. Accordingly, the start time for when data began to be acquired is listed as “19:00 on Mar. 2, 2003. The “time recorded,” i.e., the time the report was generated, may also be listed. As shown, the Progress Note was recorded at 15:32 on Mar. 3, 2003.

A Shift Report is also available for the selected patient (i.e., the top listing). This report lists a start time of 16:00 on Mar. 2, 2003. Its end time is 08:23 on Mar. 3, 2003. The reason why the start time is earlier than the start of the shift (i.e., 19:00) is because data between 16:00 and the start of the shift (i.e., 19:00) was added to the record after the report for the previous shift had been printed to the archive (i.e., the shift ending at 19:00 on Mar. 3, 2003). Accordingly, for medical and legal purposes, such data must be still be added to the optical archive, so the start time for the record is simply extended backward in time to the first time the available data for that report began to be acquired (i.e., 16:00 on Mar. 3, 2003).

Various other reports are also available, including Ventilator Flowsheet, MAR Report, and Interdisciplinary Plan reports. To view a report, the user may click on the name of the report, and the report may open up on the viewable screen for viewing or printing.

FIG. 5B illustrates an alternative archive report selection page 510 according to an embodiment of the invention. As illustrated, this alternative archive report selection page 510 may list available reports for multiple patients (e.g., Steve Johnson, Derek Terry, Zack Huber, Larry Tate, and Chip Douglas).

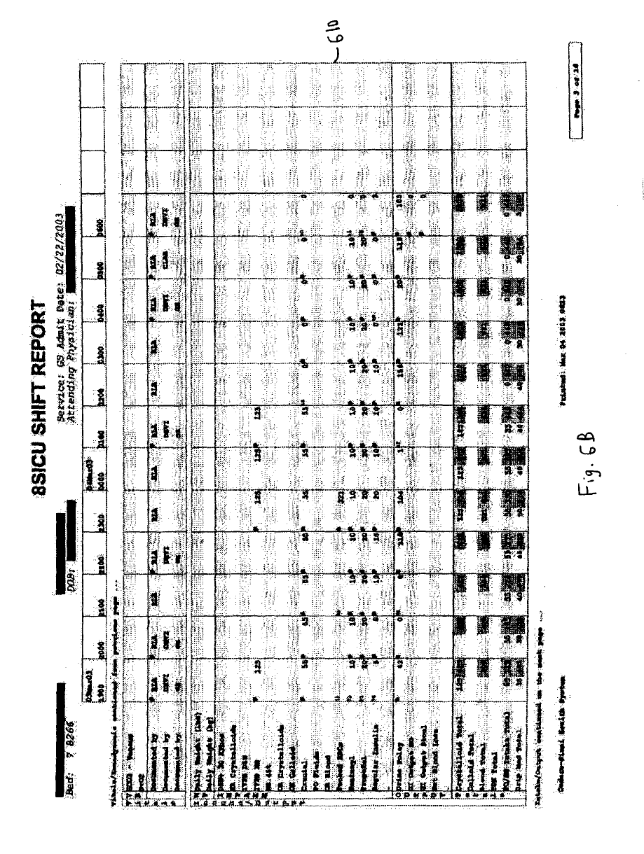

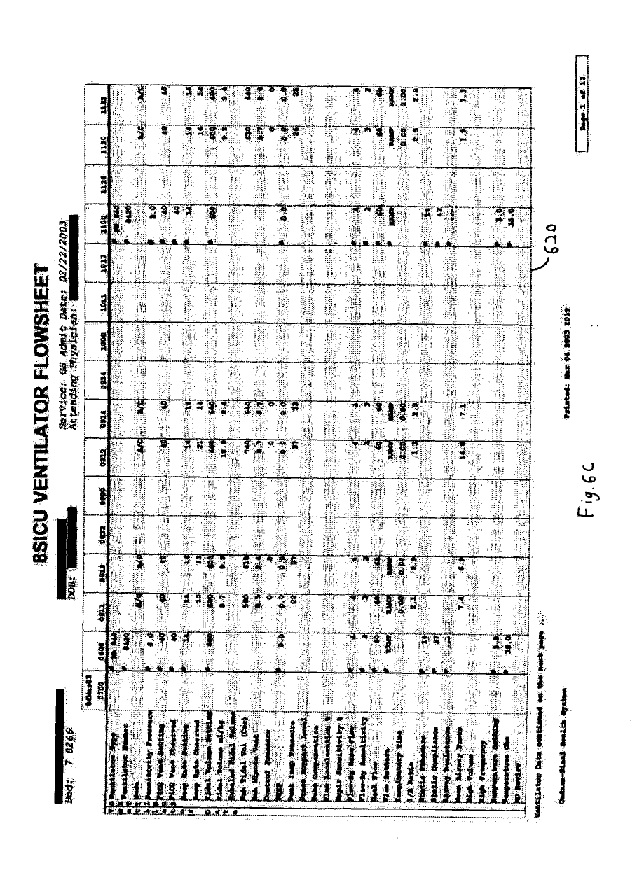

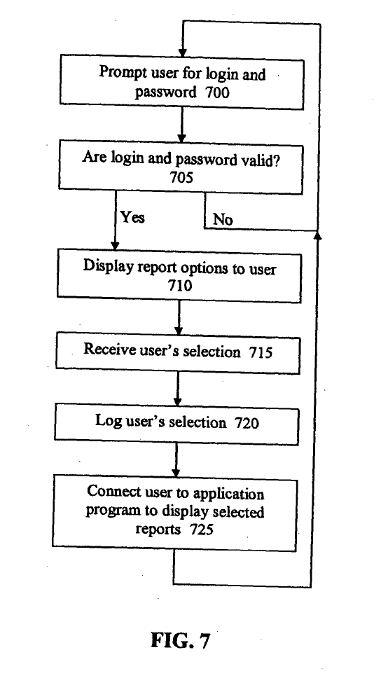

FIG. 6A illustrates an Vital Signs optical report 600 according to an embodiment of the invention. As shown, the report 600 of the Vital Signs for a patient from between 19:00 on Mar. 3, 2003, and 07:00 AM on Mar. 4, 2003. Additional information, such as the patient's age, weight, allergies, and family doctor may also be listed on the Vital Signs optical report 600. The Vital Signs optical report 600 also lists the following data for the patient: Heart Rate “108”, Rhythm “S Tachy”, Resp Rate “14” and Art BP “122/59”, etc., at 19:00 on Mar. 3, 2003.

FIG. 6B illustrates a Vital Signs and Intake/Output optical report 610 according to an embodiment of the invention. The Vital Signs and Intake/Output optical report 610 may list vitals measurements such as those of HCO3 and SvO2. Intake/output measurements may also be listed for D5W+30 KPhos, ER Crystalloids, IVPB D5W, IVPB NS, NS 45%, OR Crystalloids, OR Colloid, Crucial, PO Fluids, OR Blood, Packed RBCs, Fentanyl, Propofol, and Regular Insulin. Output measurements may also be listed for Urine Folay, GI Output NG, GI Output Stool, and Est. Blood Loss. The Vital Signs and Intake/Output optical report 610 may also list total measurements of Crystalloids, Colloids, Blood, TPN, PO/NG Intake, and Drip Med.

FIG. 6C illustrates a Ventilator Flowsheet 620 according to an embodiment of the invention. The Ventilator Flowsheet 620 may list the following information: Ventilator Type, Ventilator Number, Mode, Sensitivity Pressure, FiO2 Setting, FiO2 Vent Observed, Resp. Rate Setting, Resp. Rate Observed, Tidal Volume Setting, Tidal Volume ml/kg, Exhaled Tidal Volume, Exh. Tidal Vol. (Cor.), Exh. Minute Vent, Control Pressure, PEEP, Peak Inap. Pressure, Press. Support Level, Tube Compensation, Flow Acceleration %, Expir Sensitivity, Flow-By Base Flow, Flow-By Sensitivity, Peak Flow, Flow Pattern, Inspiratory Time, I/E Ratio, Static Pressure, Static Compliance, Airway Resistance, Mean Airway Pressure, Sigh Volume, Sign Frequency, Temperature Setting, Temperature Obs., and MD Review.

FIG. 7 illustrates a method of operating the web viewing system according to an embodiment of the invention. First, the user may be prompted 700 for a user name and login. The web viewing system may then determine 705 whether a valid login and password have been entered. If “no,” processing returns to operation 700. If “yes,” processing proceeds to operation 710, where various types of report options are displayed to the user. These options may include, e.g., the following types of reports: CAREVUE, X-rays, lab results, etc. When the user makes 715 a selection, the user's selection is logged 720 for security purposes, and then accesses the application program corresponding to the selected types of reports. Accordingly, if CAREVUE is selected, the user is then connected 725 to the CAREVUE application program, without have to re-login.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical report generation system, comprising:
a clinical information system (CIS) server to store raw monitoring data for at least one patient and to generate optical reports, at a predetermined time interval, based on the raw monitoring data, wherein the CIS server includes a database; and
a control server to determine the reports to generate, based on the raw monitoring data, wherein the optical reports include all possible optical reports which can be generated based on the raw monitoring data.

2. The optical report generation system according to claim 1, further including an optical archive to store the optical reports.

3. The optical report generation system according to claim 1, the optical archive being accessible by a web viewing system.

4. The optical report generation system according to claim 1, the control server being adapted to query a configuration of the database to determine the raw monitoring data unique to each of the optical reports.

5. The optical report generation system according to claim 1, the control server being adapted to query the database to determine a patient to which to which each of the raw monitoring data belongs.

6. The optical report generation system according to claim 1, the control server being adapted to query the database to determine the optical reports to generate for each patient.

7. The optical report generation system according to claim 1, the control server being adapted to determine a time of storage for the raw monitoring data corresponding to each of the optical reports, and adjusting a start time of the optical reports when the time of storage is earlier than the predetermined interval.

8. A method of generating optical medical reports, comprising:
storing raw monitoring data for at least one patient in a database of a clinical information system (CIS) database;
determining the reports to generate, based on the raw monitoring data, wherein the optical reports include all possible optical reports which can be generated based on the raw monitoring data; and
generating optical reports, at a predetermined time interval, based on the raw monitoring data.

9. The method according to claim 8, further including storing the optical reports in an optical archive.

10. The method according to claim 8, further including accessing the optical archive via a web viewing system.

11. The method according to claim 8, further including querying a configuration of the database to determine the raw monitoring data unique to each of the optical reports.

12. The method according to claim 8, further including querying the database to determine a patient to which to which each of the raw monitoring data belongs.

13. The method according to claim 8, further including querying the database to determine the optical reports to be generated for each patient.

14. The method according to claim 8, further including determining a time of storage for the raw monitoring data corresponding to each of the optical reports, and adjusting a start time when the time of storage is earlier than the predetermined interval.

15. An article comprising:
a storage medium having stored thereon instructions that when executed by a machine result in the following:
storing raw monitoring data for at least one patient in a database of a clinical information system (CIS) database;
determining the reports to generate, based on the raw monitoring data, wherein the optical reports include all possible optical reports which can be generated based on the raw monitoring data; and
generating optical reports, at a predetermined time interval, based on the raw monitoring data.

16. The article according to claim 15, the instructions further resulting in storing the optical reports in an optical archive.

17. The article according to claim 15, the instructions further resulting in querying a configuration of the database to determine the raw monitoring data unique to each of the optical reports.

18. The article according to claim 15, the instructions further resulting in querying the database to determine a patient to which to which each of the raw monitoring data belongs.

19. The article according to claim 15, the instructions further resulting in querying the database to determine the optical reports to be generated for each patient.

20. The article according to claim 15, the instructions further resulting in determining a time of storage for the data corresponding to each of the optical reports, and adjusting a start time of the optical reports when the time of storage is earlier than the predetermined interval.

21. A web viewing system, comprising:
a login module to prompt a user for login information;
an access module to allow the user to access a web viewing application program when the login information is valid, wherein the web viewing application program provides options to the user, the options relating to different types of optical reports;
a viewing module to provide selected optical reports to the user to view; and
a log module, to record the options selected and the optical records viewed by the user.

21. The web viewing system according to claim 20, wherein the options include CAREVUE reports.

22. The web viewing system according to claim 21, wherein the CAREVUE reports correspond to patients in an intensive care unit (ICU).

23. The web viewing system according to claim 20, wherein an interface module interfaces with report application programs to log the user into the report application programs when the login information is valid.

24. A method of providing access to a report application programs, comprising:
prompting a user for login information;
allowing the user to access a web viewing application program when the login information is valid, wherein the web viewing application program provides options to the user, the options relating to different types of optical reports;
providing selected optical reports to the user to view; and
recording the options selected and the optical records viewed by the user in a log.

25. The method according to claim 24, wherein the options include CAREVUE reports.

26. The method according to claim 25, wherein the CAREVUE reports correspond to patients in an intensive care unit (ICU).

27. The method according to claim 24, further including interfacing with the report application programs to log the user into the report application programs when the login information is valid.

28. An article comprising:
a storage medium having stored thereon instructions that when executed by a machine result in the following:
prompting a user for login information;
allowing the user to access a web viewing application program when the login information is valid, wherein the web viewing application program provides options to the user, the options relating to different types of optical reports;
providing selected optical reports to the user to view; and
recording the options selected and the optical records viewed by the user in a log.

29. The article according to claim 28, wherein the options include CAREVUE reports.

30. The article according to claim 29, wherein the CAREVUE reports correspond to patients in an intensive care unit (ICU).

31. The article according to claim 28, wherein the instructions further result in interfacing with the report application programs to log the user into the report application programs when the login information is valid.
